(19) United States
(12) Patent Application Publication
(10) Pub. No.: US 2020/0160289 A1
(43) Pub. Date: May 21, 2020

(54) LAZY UPDATING AND STATE PREDICTION FOR BLOCKCHAIN-BASED APPLICATIONS

(71) Applicant: Rare Bits, Inc., San Francisco, CA (US)

(72) Inventors: Amitt Mahajan, San Francisco, CA (US); Payom Dousti, San Francisco, CA (US); Gary Button, San Francisco, CA (US)

(21) Appl. No.: 16/681,821

(22) Filed: Nov. 13, 2019

Related U.S. Application Data
(60) Provisional application No. 62/769,491, filed on Nov. 19, 2018.

(51) Int. Cl. G06Q 20/06; G06F 16/23

(52) U.S. Cl. CPC G06Q 20/065; G06F 16/2365; G06F 16/2379

(57) ABSTRACT

A lazy updating system where a traditional non-blockchain database is updated first and applies a state change to a blockchain lazily while still allowing a client application to perform operations on the new state is disclosed. The lazy updating system enables transactions related to blockchain-based goods to use one or more databases (e.g., local or distributed databases) to mirror blockchain state. Operations such as displaying a user interface (UI) with the current state of the blockchain use these databases instead of the blockchain directly to enable faster loading times. Instead of waiting for a blockchain to confirm a change to the state of their goods, the lazy updating system enables a service to first update its local database with a given change to allow users to interact with the new state and execute the blockchain transaction in the background with the assumption that the given change will eventually be confirmed.

### CROSS-REFERENCES TO RELATED APPLICATIONS

This application claims the benefit of U.S. Provisional Patent Application Ser. No. 62/769,491, filed on Nov. 19, 2018, and entitled “LAZY UPDATING AND STATE PREDICTION FOR BLOCKCHAIN-BASED APPLICATIONS,” the disclosure of which is hereby incorporated herein in its entirety by reference.

### BACKGROUND AND OVERVIEW

Blockchain was invented by Satoshi Nakamoto to serve as the public transaction ledger of the cryptocurrency bitcoin. It was developed to allow electronic cash to be transferred directly from one party to another without going through a financial institution, as described in the white paper entitled “Bitcoin: A Peer-to-Peer Electronic Cash System” by Satoshi Nakamoto. While it was invented for use by bitcoin, blockchain is now used to transfer assets using other cryptocurrencies as well. An asset (e.g., an electronic coin, a blockchain-based good, and so on) is represented by a chain of transactions that transfers ownership from one party to another party. To transfer ownership of an asset on a blockchain, a new transaction is generated and added to a stack of transactions in a block. The new transaction, which includes the public key of the new owner, is digitally signed by the owner with the owner's private key to transfer ownership to the new owner as represented by the new owner public key. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of an asset did not double-spend the asset (i.e., transfer ownership of the same asset to two parties), the blockchain system maintains a distributed ledger of transactions. With the distributed ledger, a ledger of all the transactions for an asset is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The blockchain system also implements techniques to ensure that each node will store the identical blockchain, even though nodes can receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The blockchain system also implements techniques to ensure that it would be infeasible to change a transaction and regenerate the blockchain by employing a computationally expensive technique to generate a nonce that is added to the block when it is created. A blockchain ledger is sometimes referred to as an Unspent Transaction Output (“UXTO”) set because it tracks the output of all transactions that have not yet been spent.

Although current blockchain systems have been very successful, they are limited to transactions in bitcoins or other cryptocurrencies. Efforts are currently underway to use blockchains to support transactions of any type, such as those relating to the sale of vehicles, sale of financial derivatives, sale of stock, payments on contracts, and so on. Such transactions use identity tokens, which are also referred to as digital bearer bonds, to uniquely identify something that can be owned or can own other things. An identity token for a physical or digital asset is generated using a cryptographic one-way hash of information that uniquely identifies the asset. Tokens also have an owner that uses an additional public/private key pair. The owner public key is set as the token owner identity and when performing actions against tokens, ownership proof is established by providing a signature generated by the owner private key and validated against the public key listed as the owner of the token. A person can be uniquely identified, for example, using a combination of a user name, social security number, and biometric (e.g., fingerprint). A product (e.g., refrigerator) can be uniquely identified, for example, using the name of its manufacturer and its serial number. The identity tokens for each would be a cryptographic one-way hash of such combinations. The identity token for an entity (e.g., person or company) can be the public key of a public/private key pair, where the private key is held by the entity. Identity tokens can be used to identify people, institutions, commodities, contracts, computer code, equities, derivatives, bonds, insurance, loans, documents, and so on. Identity tokens can also be used to identify collections of assets. An identity token for a collection can be a cryptographic one-way hash of the digital tokens of the assets in the collection. The creation of an identity token for an asset in a blockchain establishes provenance of the asset, and the identity token can be used in transactions (e.g., buying, selling, insuring) of the asset stored in a blockchain, creating a full audit trail of the transactions.

To record a simple transaction in a blockchain, each party and asset involved with the transaction needs an account that is identified by a digital token. For example, when one person wants to transfer a car to another person, the current owner and next owner create accounts, and the current owner also creates an account that is uniquely identified by its vehicle identification number. The account for the car identifies the current owner. The current owner creates a transaction against the account for the car that indicates that the transaction is a transfer of ownership, indicates the public keys (i.e., identity tokens) of the current owner and the next owner, and indicates the identity token of the car. The transaction is signed by the private key of the current owner and the transaction is evidence that the next owner is now the current owner.

To enable more complex blockchain-based transactions, some systems use “smart contracts.” A smart contract is computer code that implements transactions of a contract. The computer code can be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, which initializes the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain.

For example, a smart contract can support the sale of an asset (also called a crypto-good or a non-fungible token (NFT)), such as tickets, gift cards, virtual game items, and so on. A user can visit a website that enables interactions with the asset. These assets and their owners are stored on a blockchain and can be exchanged using a smart contract. The smart contract allows listing of goods, purchasing of listed goods, and the transfer of goods. All of these transactions and changes in ownership occur “on-chain” and are denominated in a crypto-currency. The inputs to a smart contract to sell a car can be the identity tokens of the seller, the buyer, the asset/crypto-good/NFT (i.e., the car) and the sale price in U.S. dollars. The computer code ensures that the seller is the current owner of the car and that the buyer has sufficient funds in her account. To do so, a user is required to use her “private key” to “sign” a transaction. This allows goods or funds to be withdrawn from her wallet and be sent to another user or to a smart contract. The computer code then records a transaction that transfers the ownership of the car to the buyer and a transaction that transfers the sale price from the buyer's account to the seller's account. If the seller's account is in U.S. dollars and the buyer's account is in Canadian dollars, the computer code can retrieve a currency exchange rate, determine how many Canadian dollars the seller's account should be debited, and record the exchange rate. If either transaction is not successful, neither transaction is recorded.

The term “contract” has been used to describe the computer code of a contract under the UXTO model of bitcoin and the computer code of the “smart contracts” model of the Ethereum platform. The “contracts” under these models are, however, different. In the UXTO model, the distributed ledger is a set of immutable rows keyed by (hash: output index) values. The “hash” is a hash of the transaction that generated the output represented by the row, and the “output index” identifies which one of the possibly many outputs of the transaction the row represents. A UXTO contract is deterministic and performs no processing other than validating the inputs to the transaction. In the “smart contract” model, the computer code of the smart contract is an instantiation of the computer code that is maintained by every node that stores the block chain. A “smart contract” can perform virtually any type of processing such as receiving messages, sending messages, accessing external databases, and so on.

### BRIEF DESCRIPTION OF THE DRAWINGS

FIG. 1 is a block diagram showing some of the components typically incorporated in at least some of the computer systems and other devices on which the lazy updating system operates.

FIG. 2 illustrates an example of a communications environment in which some embodiments of the lazy updating system can be utilized.

FIGS. 3A and 3B are flow diagrams showing a process performed by the lazy updating system in some embodiments.

FIG. 4 is a display diagram illustrating an example user interface for signing a transaction.

FIG. 5 is a display diagram illustrating an example user interface for publishing a signed transaction.

FIG. 6 is a system diagram illustrating an example of a computing environment in which the lazy updating system operates in some embodiments.

FIGS. 7A-7D are display diagrams illustrating an example user interface for placing a bid for an item listed for auction.

The drawings have not necessarily been drawn to scale. Similarly, some components and/or operations can be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Traditional blockchain systems enable users to perform transactions (e.g., sell, buy, and/or trade blockchain-based goods) using, for example, smart contracts. When a message is sent to a smart contract to record a transaction, the message is sent to each node that maintains a replica of the blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide which transactions to keep and which transactions to discard. Although the execution of the computer code at each node helps ensure the authenticity of the blockchain, it requires large amounts of computer resources to support such redundant execution of the computer code. These transactions take some time to execute and be confirmed (a period of waiting time to ensure that the transaction was valid and won't be reversed). As a result of this blockchain latency, user experience is negatively impacted by having users wait for long periods of time for the blockchain to be updated.

To overcome these deficiencies, a lazy updating and state prediction for blockchain-based applications system (“a lazy updating system”) is disclosed herein that utilizes local databases to track state changes of blockchain-based goods. For example, the lazy updating system enables transactions related to blockchain-based goods to use one or more databases (e.g., local or distributed databases) to mirror blockchain state. Operations such as displaying a user interface (UI) with the current state of the blockchain may use these databases instead of the blockchain directly to enable faster loading times and other operations. The lazy updating system decouples the UI state of an application from the blockchain. This makes it easier to build blockchain based applications. Instead of waiting for a blockchain to confirm a change to the state of their goods (such as a transfer to another user or a new good being minted and assigned to a user), the lazy updating system enables a service to first update its local database with a given change to allow users to interact with the new state and then execute the blockchain transaction in the background with the assumption that the given change will eventually be confirmed. The lazy updating system provides users with a responsive user experience that does not require the blockchain state to be current to take action. For example, the lazy updating system enables a service to sell packs of crypto-based digital trading cards that users can use immediately even if they haven't been minted yet on the blockchain. In several implementations, the lazy updating system combines off-chain state storage with on-chain state/source-of-truth and delivers a much smoother user experience. Lazy updating of the blockchain enables “fold-writes” and batches multiple actions into a single blockchain transaction. This saves on gas costs (i.e. computation transaction costs) and reduces the burden on the overall blockchain network.

As an example, users can use an application associated with the lazy updating system to buy blockchain-based gift cards with redeemable codes. For example, users can buy ERC271 backed gift cards, scratch this code in order to redeem the gift card's value on some 3rd-party site, and transfer the gift card to another user. If a user purchases a new gift card, they may want to use that gift card immediately. If the application has to wait for the gift card's NFT to be minted and confirmed on the blockchain, the user can be waiting several minutes before being able to use their gift card. This is not a great user experience. Instead, the lazy updating system enables the application to update its local database with the new gift card and the user as the current owner. From the user's perspective, they see a new gift card in their account and can interact with it to perform actions like an animated scratching of a box on the card to reveal the code. Only if they try to take an action that requires the blockchain state to have been updated (such as transferring the gift card to another user), will they be blocked. Meanwhile, the application transmits the “mint” transaction to the blockchain and monitors its state to ensure that the action goes through.

In several implementations, the lazy updating system performs predictions of blockchain state that allow it to provide an enhanced user experience. In several implementations, the lazy updating system predicts several state changes ahead instead of just a single operation. The number of state changes predicted can increase the complexity of a rollback. State prediction can be based on the application/website. For example, when an application mainly deals with ownership of non-fungible or fungible tokens, the application can predict a user's ownership of those tokens before a transaction transferring those tokens has completed. As another example, when there is some state related to a non-fungible token, such as whether or not a scratch off card has been “redeemed” or not, the application can assume that the state has been changed and update the database and/or UI accordingly before the blockchain transaction officially confirms the change.

In the following description, for the purposes of explanation, numerous specific details are set forth in order to provide a thorough understanding of embodiments of the present technology. It will be apparent, however, to one skilled in the art that embodiments of the present technology can be practiced without some of these specific details. For instance, while the lazy updating system described herein is in relation to the blockchain, it is feasible to imagine using the lazy updating with any application that has high latency properties. A salient feature of the lazy updating system is detecting and rectifying discrepancies in a slow primary data store with the faster secondary store from which the UI is displayed. In several implementations, the lazy updating system can be used in applications that are dependent upon several separate data stores which all have varying latency. In such application, the lazy updating system can be used to rectify the differences between each external store while maintaining a unified and unambiguous state to the end user, while gracefully handling backpropagated state changes from the primary store if things are not finalized in the same way as predicted. For example, for a connected home that has a data store or several data stores which coordinate a set of internet connected devices, the lazy updating system can be used on each device interface as a means to show predicted consensus from the interactions with other devices.

The techniques introduced here can be embodied as special-purpose hardware (e.g., circuitry), as programmable circuitry appropriately programmed with software and/or firmware, or as a combination of special-purpose and programmable circuitry. Hence, embodiments can include a machine-readable medium having stored thereon instructions which can be used to program a computer (or other electronic devices) to perform a process. The machine-readable medium can include, but is not limited to, floppy diskettes, optical disks, compact disc read-only memories (CDROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in several embodiments,” “in some embodiments,” “according to several embodiments,” “in the embodiments shown,” “in other embodiments,” and the like generally mean the particular feature, structure, or characteristic following the phrase is included in at least one implementation of the present technology, and can be included in more than one implementation. In addition, such phrases do not necessarily refer to the same embodiments or different embodiments.

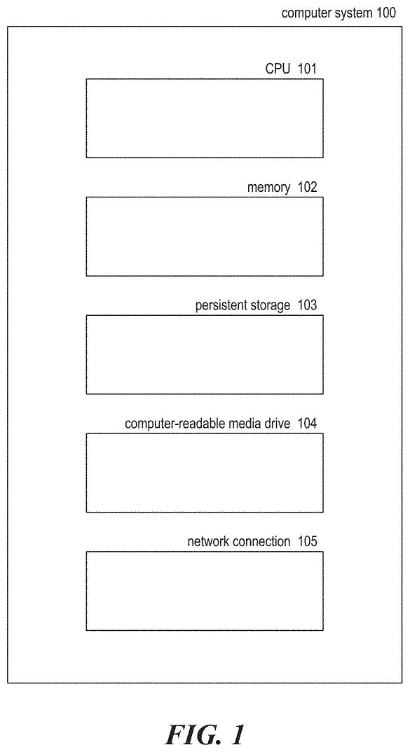

FIG. 1 is a block diagram showing some of the components typically incorporated in at least some of the computer systems and other devices on which the lazy updating system operates. In various embodiments, these computer systems and other devices 100 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 101 for executing computer programs; a computer memory 102 for storing programs and data while they are being used, including the lazy updating system and associated data, an operating system including a kernel, and device drivers; a persistent storage device 103, such as a hard drive or flash drive for persistently storing programs and data; a computer-readable media drive 104 that is a tangible storage means that does not include a transitory, propagating signal, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the lazy updating system can be implemented using devices of various types and configurations, and having various components.

The lazy updating system can be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules can be combined or distributed as desired in various examples. Aspects of the lazy updating system can be implemented in hardware using, for example, an application-specific integrated circuit (ASIC) or field programmable gate array (“FPGA”).

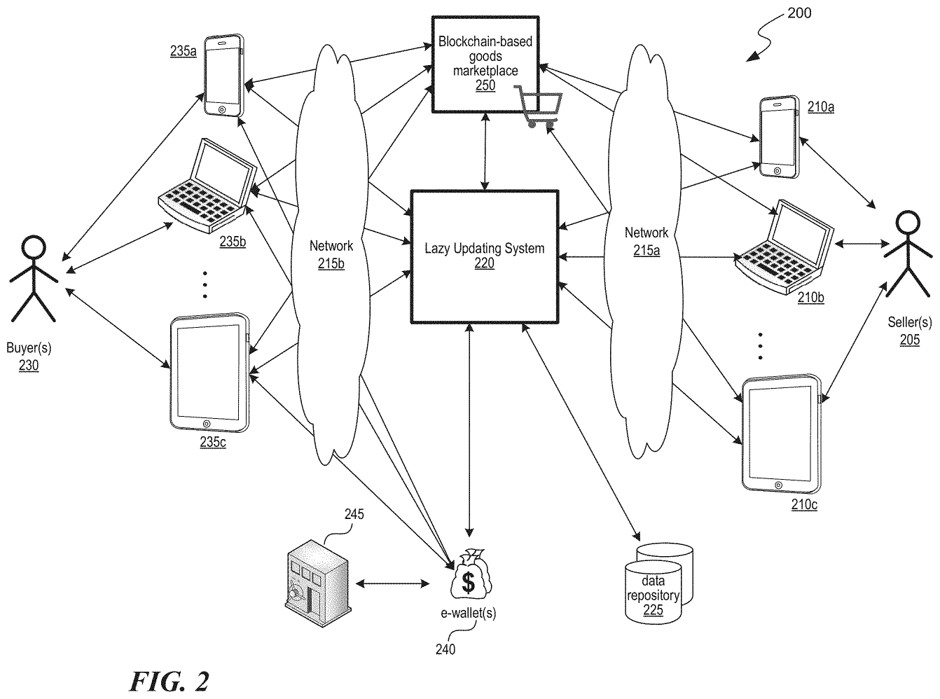

FIG. 2 illustrates an example of a communications environment 200 in which some embodiments of the lazy updating system can be utilized. In various embodiments, environment 200 comprises a lazy updating system 220. Seller(s) 205 can use various electronic devices (e.g., mobile device 210a, laptop/PC 210b, tablet 210c, and so on) to list one or more goods/assets for sale on the blockchain. In several embodiments, seller(s) 205 can list the blockchain goods/assets for sale directly at a blockchain-based goods marketplace 250, a blockchain smart contract platform based on, for example, Ethereum, and so on via a communications network 215a, such as a Local Area Network (“LAN”), Wide Area Network (“WAN”), the Internet, and the like. Seller(s) 205 can also communicate with a lazy updating system 220 via communications network 215a (e.g., using web services) regarding goods/assets listed for sale in an auction setting. In several embodiments, the blockchain-based goods marketplace 250 is integrated with the lazy updating system 220 (e.g., as an integrated e-commerce auction platform for blockchain-based goods/assets).

Buyer(s) 230 can use various electronic devices (e.g., mobile device 235a, laptop/PC 235b, tablet 235c, and so on) to browse, search for, and purchase one or more goods/assets listed for sale on the blockchain. For example, buyer(s) 230 can access an integrated e-commerce platform for blockchain-based goods/assets via communications network 215b (e.g., using web services). Buyer(s) 230 and/or the lazy updating system 220 can also communicate with one or more blockchain wallets 240 (for example, using a cryptocurrency account), which may be in communication with a cryptocurrency provider 245, to provide payment for the purchased blockchain-based goods/assets. The lazy updating system 220 can also communicate with one or more data storage repositories 225 to store and/or access information about one or more goods/assets listed for sale (e.g., good/asset identifier, description, selling price, seller, quantity, auction price, minimum bid price, reserve price, bid price increment value(s), auction structure, shipping information, etc.), seller(s) (e.g., seller identifier, name, address, contact information, ratings, etc.), buyer(s) (e.g., buyer identifier, name, address, contact information, ratings, cryptocurrency address(es), etc.), transactions, asset state(s), and so on.

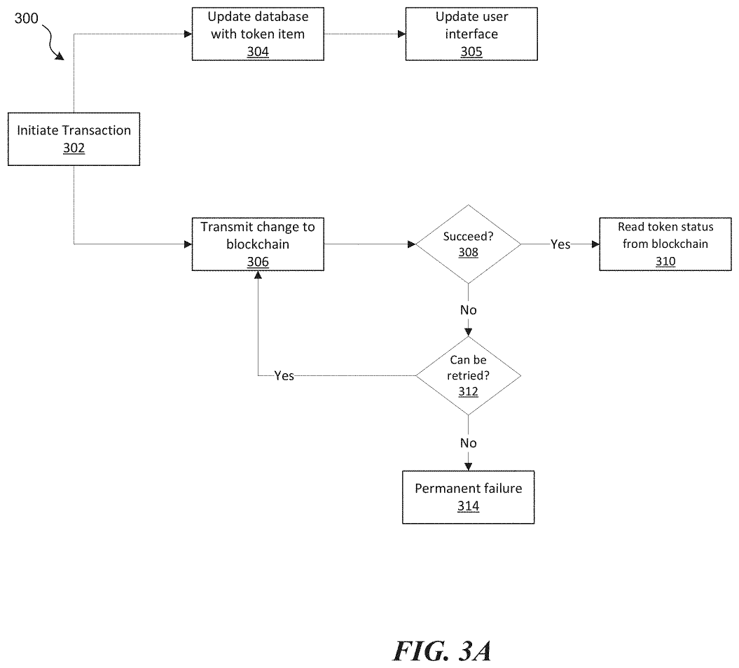

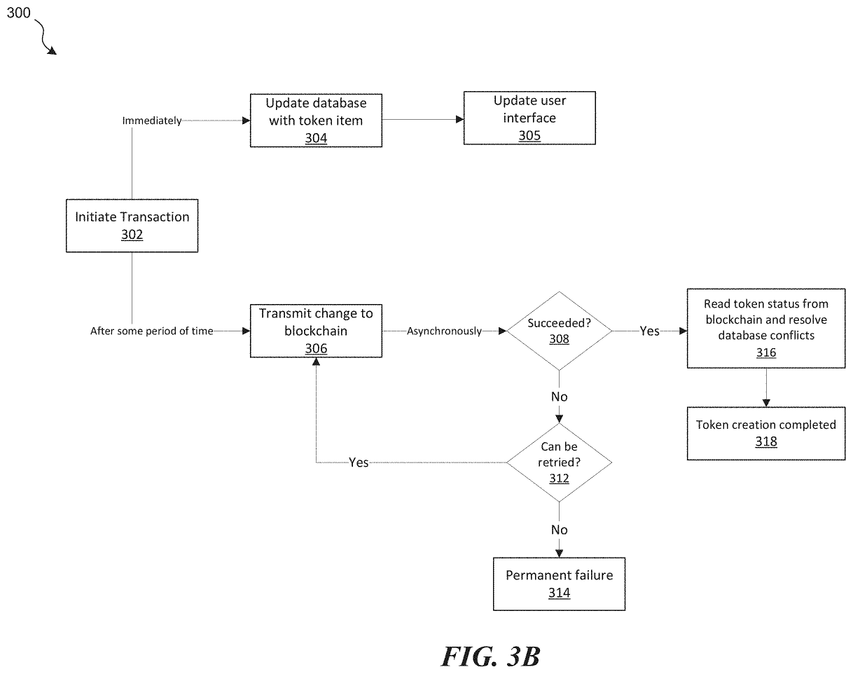

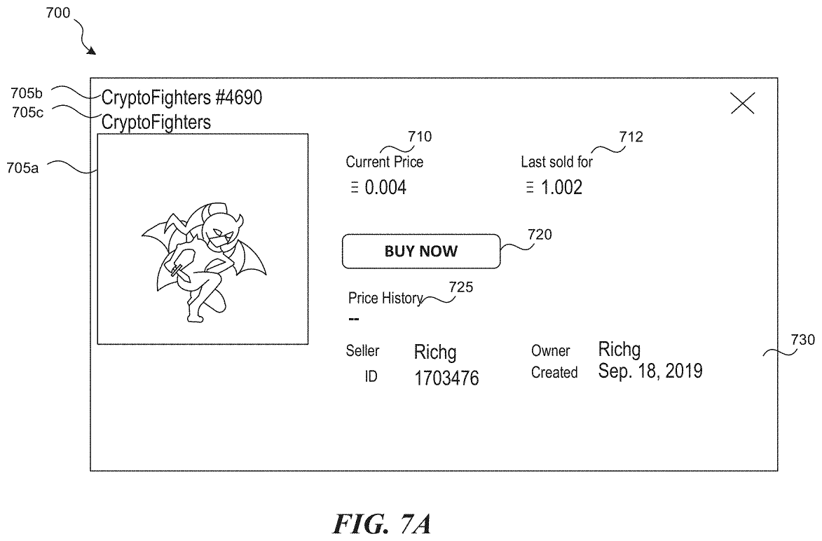

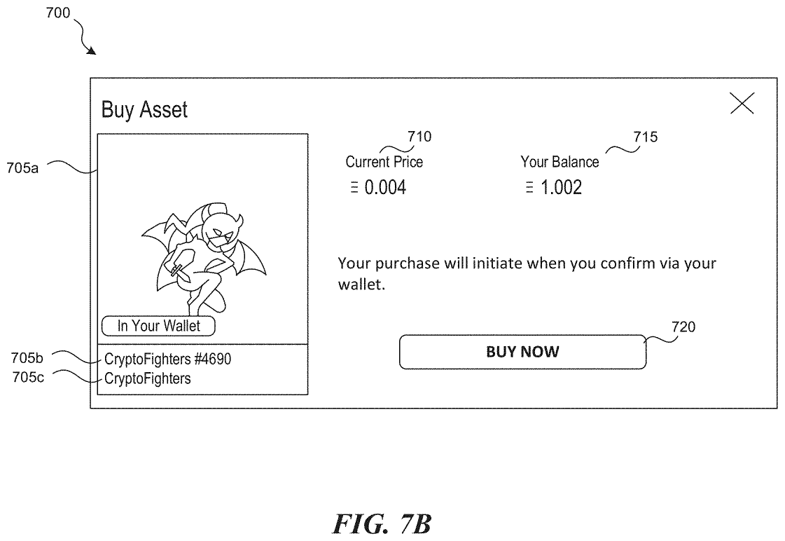

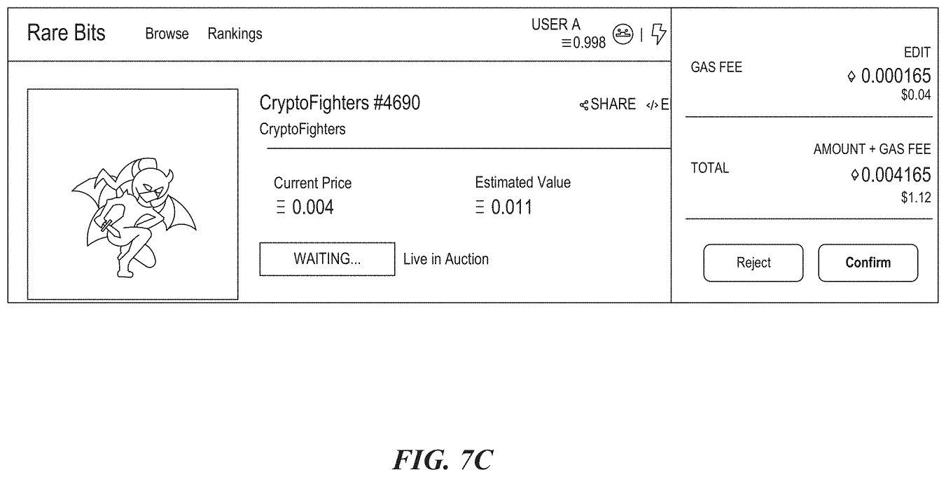

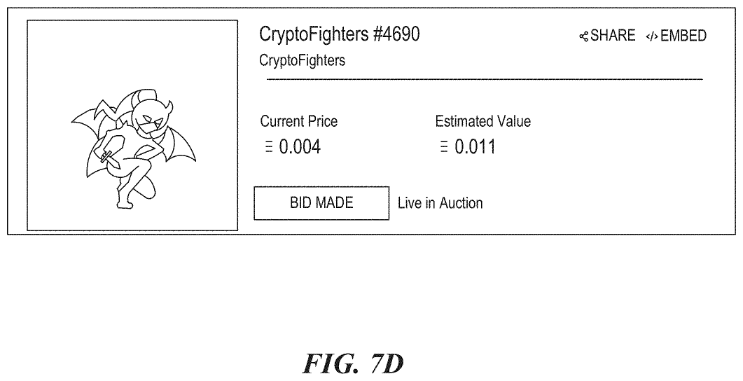

FIGS. 3A and 3B are flow diagrams showing a process 300 performed by the lazy updating system in some embodiments. At block 302, a user that wishes to perform a transaction (e.g., buy, sell, and/or trade a blockchain-based good/asset, reward redemption, and so on) performs an action on a given website or application (for example, managed by/associated with the lazy updating system 220) that will modify the state of the blockchain to reflect the transaction. FIGS. 7A-7D are display diagrams illustrating an example user interface for placing a bid for an item listed for auction. For example, as shown in FIGS. 7A-7B, a buyer interested in buying a right in a listed blockchain-based good/asset is presented with a user interface 700 that he/she can use to place a bid. The buyer can view information about the listed blockchain-based good/asset (for example, image 705a, item name 705b, item category/type 705c, and so on), current price 710, last sold for price 712, starting auction price, buyer's wallet balance 715, price history 725, seller and/or owner information 730, and so on. Once the buyer selects control 720 to place a bid on a selected blockchain-based good/asset, the buyer can be prompted to sign a transaction for storage in the bid matching service. For example, as shown in FIG. 7C, for a frictionless user experience, the user interface defaults to the ask price which will result in immediate matching and therefore execution of the exchange.

At block 304, the application updates one or more databases (e.g., local database(s) and/or distributed database(s)), and enqueues the state change for future processing. This updates the user's UI (block 305) and the user can continue to act as if the state change already occurred. For example, the lazy updating system can create/update a token item (e.g., NFT, fungible token, and so on) associated with the blockchain-based good/asset. In some implementations, when certain UI actions require a certain quantity of fungible tokens, an application can choose to allow the user to take the action even before the blockchain has confirmed the user official owns the tokens. This is similar to an application extending credit to the user based on some certainty that the blockchain will reflect the user's balance. Applications can choose when to update their databases based on a prediction score and/or trigger event (such as, predetermined frequency, time period, number of transactions, type of transaction, priority of transaction, buyer identity, seller identity, currency, and so on). Instead of updating immediately, for example, an application can wait till there is at least one confirmation or a series of other events that can ensure that a transaction will not be rejected by the blockchain.

At block 306, the application transmits the change to the blockchain (e.g., as a background/asynchronous/synchronous process) and waits for confirmation that the change occurred. For instance, the application executes mint and transfer of the token item on the blockchain. This could take a few seconds to several minutes or hours. Applications can choose when to update the blockchain based on a prediction score and/or trigger event (such as, predetermined frequency, time period, number of transactions, type of transaction, priority of transaction, buyer identity, seller identity, currency, and so on). A prediction score can be based on a type of the application and/or a weighting of several different factors, such as the user's previous purchase/transaction history, whether or not the amount of fungible tokens is a large part of their existing balance, whether or not the source account of the transaction is controlled by the application (for example, the application is the one doing the transferring/minting of a token), the gas price of the transaction (high gas price transactions go through and are confirmed more quickly), the number of confirmations on a transaction that has been already submitted, and so on.

After the change has been confirmed (at block 308), the lazy updating system marks the change as confirmed to prevent any retries (block 310). The transaction state goes to a closed state and the transaction activity is marked as completed. For instance, the lazy updating system can update a state change indicator (closed) on the local database and/or read the current state of the blockchain. The lazy updating system can also read token status from the blockchain and resolve any conflicts with the database (at block 316), after which token creation is completed (block 318).

However, if the transaction failed on the blockchain, the application's background process can optionally choose to retry the transaction (at block 312). When the transaction can be retried, process 300 returns to block 306. In the case that the transaction permanently fails (transaction cannot be retried or has been retried a certain number of times), the lazy updating system needs to roll back the changes in its local database and undo any additional actions the user took to maintain state parity with the blockchain (block 314). The techniques for rolling back the changes can be application specific. One or more of the following techniques can be implemented to minimize the impact of rollbacks: limiting the number of transactions being predicted forward, using a prediction score to determine how much leeway to allow the state to be changed, keeping a record of blockchain-confirmed state and predicted state, and so on. The prediction score can be based on a type of the token (NFT, fungible, and so on) and/or a value of the token. When a transaction is rolled-back, the database can just revert back to the blockchain-confirmed state. This can potentially be a complicated or impossible process depending on the complexity of the application. In some implementations, the lazy updating system that does not need to unwind user actions can decide not to implement a rollback system; instead it can just update its records by copying the latest confirmed blockchain state over its predicted state. In several embodiments, the lazy updating system can batch the lazy updating of the blockchain. For instance, an application can allow the user to take multiple actions that modify state and only transmit a single event to the blockchain that is a combination of all of the intended state changes.

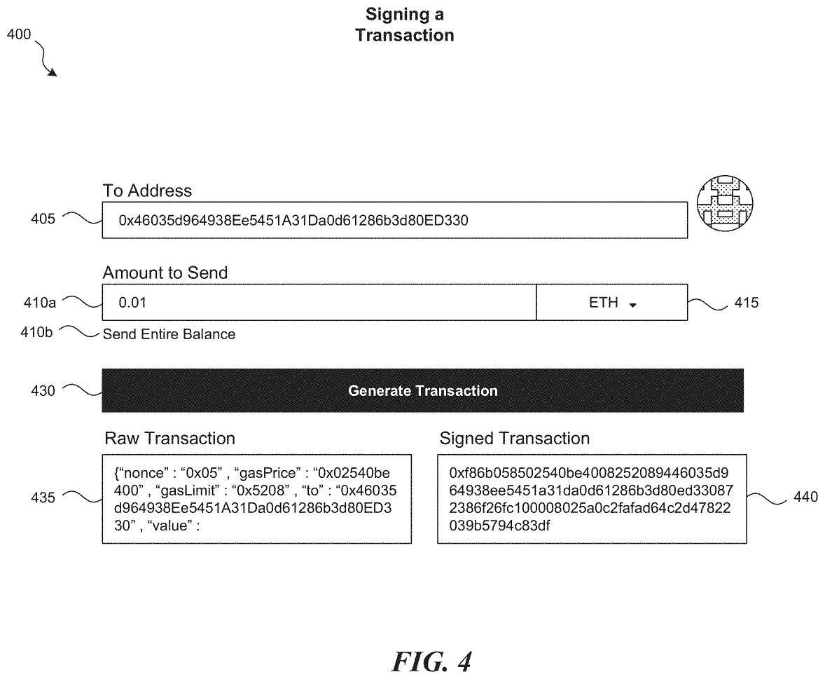

FIG. 4 is a display diagram illustrating an example user interface 400 for signing a transaction. Buyer 320 (and/or any other authorized entity authorized by the buyer) can enter (and/or view) information at user interface 400. In several embodiments, when buyer 320 has authorized a purchase amount up to a certain limit (for example, a preconfigured amount), the buyer may be able to provide a “blank cheque” with a limit transaction that allows the lazy updating system to fill in the eventual purchase price. Buyer 320 can provide the following information to the lazy updating system during signing of the transaction: recipient address 405 (address of the smart contract that is handling the auction execution), amount to send 410a, amount currency 415 (for example, BTC Bitcoin, ETH Ethereum, XRP Ripple, BCH Bitcoin Cash, and so on), option to send the entire balance 410b (or send it in increments), and so on. In several embodiments, if the wallet is a “multi-signature” wallet, then multiple parties sign the transaction before executing it. Upon selection of the “Generate Transaction” option 430, user interface 400 can display both the raw transaction data 435 and the signed transaction data 440. Raw transaction data may be an encoded command (for example, an encoded Ethereum command). The signed transaction data can be generated using a nonce, the amount of ether, the raw transaction data, etc., to generate a signed transaction.

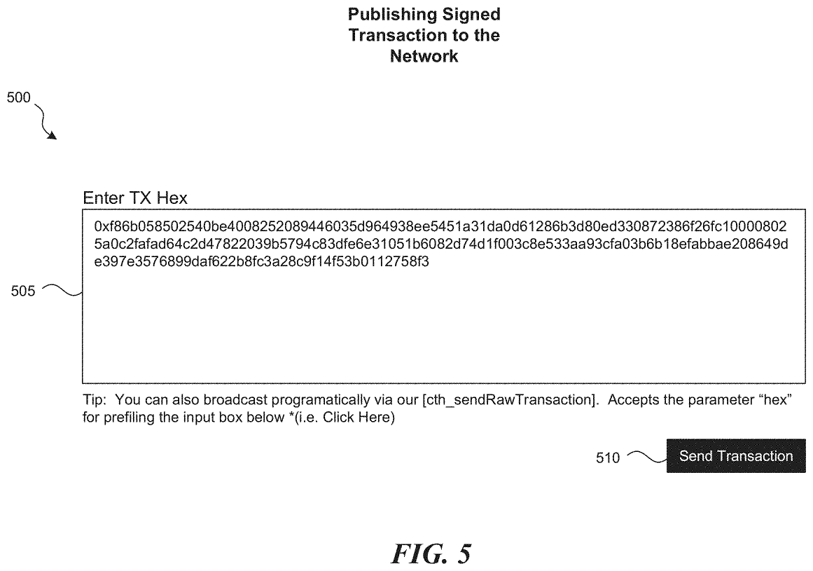

FIG. 5 is a display diagram illustrating an example user interface 500 for publishing a signed transaction. In several embodiments, user interface 500 displays an encrypted value of the signed transaction (for example, a hex value of the transaction) 505. Upon selection of the “Send Transaction” option 510, the lazy updating system publishes/broadcasts the signed transaction so that it can be broadcast to the blockchain and miners can begin mining the transaction to add it to the blockchain.

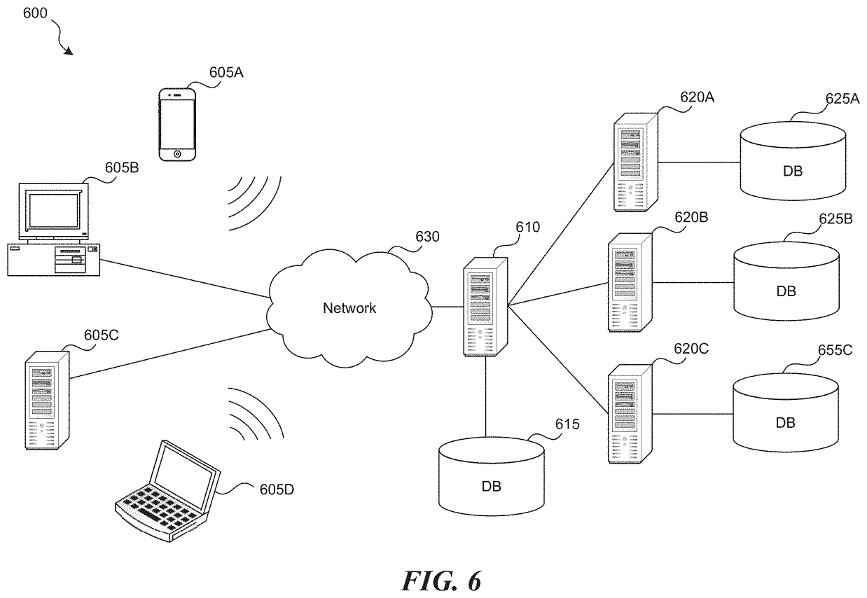

FIG. 6 is a system diagram illustrating an example of a computing environment in which the lazy updating system operates in some embodiments. In some implementations, environment 600 includes one or more client computing devices 605A-D, examples of which can include computer system 100. Client computing devices 605 operate in a networked environment using logical connections 610 through network 630 to one or more remote computers, such as a server computing device.

In some implementations, server 610 is an edge server which receives client requests and coordinates fulfillment of those requests through other servers, such as servers 620A-C. In some implementations, server computing devices 610 and 620 comprise computing systems, such as computer system 100. Though each server computing device 610 and 620 is displayed logically as a single server, server computing devices can each be a distributed computing environment encompassing multiple computing devices located at the same or at geographically disparate physical locations. In some implementations, each server 620 corresponds to a group of servers.

Client computing devices 605 and server computing devices 610 and 620 can each act as a server or client to other server/client devices. In some implementations, servers (610, 620A-C) connect to a corresponding database (615, 625A-C). As discussed above, each server 620 can correspond to a group of servers, and each of these servers can share a database or can have its own database. Databases 615 and 625 warehouse (e.g., store) information such as user data (e.g., user identifiers, user profiles, etc.), good/asset data (e.g., identifier, name, description, price, quantity, auction amount, etc.), cryptocurrency addresses, fiat-to-cryptocurrency and cryptocurrency-to-fiat exchange rates, etc. Though databases 615 and 625 are displayed logically as single units, databases 615 and 625 can each be a distributed computing environment encompassing multiple computing devices, can be located within their corresponding server, or can be located at the same or at geographically disparate physical locations.

Network 630 can be a local area network (LAN) or a wide area network (WAN), but can also be other wired or wireless networks. In some implementations, network 630 is the Internet or some other public or private network. Client computing devices 605 are connected to network 630 through a network interface, such as by wired or wireless communication. While the connections between server 610 and servers 620 are shown as separate connections, these connections can be any kind of local, wide area, wired, or wireless network, including network 630 or a separate public or private network.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further any specific numbers noted herein are only examples: alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology can include not only additional elements to those implementations noted above, but also can include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system can vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects can likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computer-implemented method for performing lazy updates of transactions to a blockchain, the method comprising:
receiving, via an application, at least one action to initiate a transaction related to a blockchain-based asset,
wherein executing of the transaction changes a state of the blockchain to reflect the transaction;
updating, at a first time, at least one data storage location with information related to the transaction,
wherein the updating of the at least one data storage location comprises creating or updating a token item associated with the blockchain-based asset;
updating a user interface to reflect the updating of the at least one data storage location;
at a time later than the first time, transmitting the transaction to the blockchain for execution;
receiving a confirmation of the execution of the transaction on the blockchain;
when the confirmation of the execution of the transaction on the blockchain indicates that the transaction executed successfully:
marking the transaction as complete to prevent retries; and
changing a transaction state to a closed state; and
when the confirmation of the execution of the transaction on the blockchain indicates that the transaction did not execute successfully:
determining whether the transaction can be retried;
when the transaction can be retried, retrying the transaction; and
when the transaction cannot be retried:
rolling back changes made to the at least one data storage location with information related to the transaction; and
undoing additional actions taken by a user after the updating of the at least one data storage location with information related to the transaction.

2. The computer-implemented method of claim 1, wherein the information related to the transaction comprises:
identity of the blockchain-based asset,
identity of a user associated with the transaction,
type of the transaction,
currency associated with the transaction,
or any combination thereof.

3. The computer-implemented method of claim 1, wherein the at least one transaction is transmitted to the blockchain based on a prediction score or a trigger event.

4. The computer-implemented method of claim 3, wherein the trigger event is based on:
a configurable frequency,
a time period,
number of transactions,
type of the transaction,
priority of the transaction,
identity of a buyer associated with the transaction,
identity of a seller associated with the transaction,
currency associated with the transaction,
or any combination thereof.

5. The computer-implemented method of claim 3, wherein the prediction score is based on:
type of the application,
transaction history of a user associated with the transaction,
type of the transaction,
amount associated with the transaction,
gas price of the transaction,
number of previously submitted confirmations for the transaction,
or any combination thereof.

6. The computer-implemented method of claim 1, further comprising:
executing the at least one transaction to change the state of the blockchain to reflect the at least one transaction.

7. The computer-implemented method of claim 1, wherein the updating of the at least one data storage location is based on a prediction score or a trigger event.

8. The computer-implemented method of claim 5, wherein the trigger event is based on:
a configurable frequency,
a time period,
number of transactions,
type of the at least one transaction,
priority of the at least one transaction,
identity of a buyer associated with the at least one transaction,
identity of a seller associated with the at least one transaction,
currency associated with the at least one transaction,
or any combination thereof.

9. The computer-implemented method of claim 1, further comprising:
receiving confirmation or a set of events confirming that the transaction will not be rejected by the blockchain,
wherein the updating of the at least one data storage location occurs after the confirmation or the set of events is received.

10. The computer-implemented method of claim 1, wherein when the confirmation of the execution of the transaction on the blockchain indicates that the transaction executed successfully:
updating a state change indicator to closed at the at least one data storage location; and
reading a current state of the blockchain to resolve discrepancies at the at least one data storage location.

11. The computer-implemented method of claim 1, wherein determining whether the transaction can be retried comprises:
determining a number of times the transaction has previously been tried; and
when the number of times the transaction has previously been tried exceeds a predetermined threshold, determining that the transaction cannot be retried.

12. At least one non-transitory, computer-readable medium carrying instructions, which when executed by at least one data processor, performs operations for performing lazy updates of transactions to a blockchain, the operations comprising:
receiving, via an application, at least one action to initiate a transaction related to a blockchain-based asset,
wherein executing of the transaction changes a state of the blockchain to reflect the transaction;
updating, at a first time, at least one data storage location with information related to the transaction,
wherein the updating of the at least one data storage location comprises creating or updating a token item associated with the blockchain-based asset;
updating a user interface to reflect the updating of the at least one data storage location;
at a time later than the first time, transmitting the transaction to the blockchain for execution;
receiving a confirmation of the execution of the transaction on the blockchain;
when the confirmation of the execution of the transaction on the blockchain indicates that the transaction executed successfully:
marking the transaction as complete to prevent retries; and
changing a transaction state to a closed state; and
when the confirmation of the execution of the transaction on the blockchain indicates that the transaction did not execute successfully:
determining whether the transaction can be retried;
when the transaction can be retried, retrying the transaction; and
when the transaction cannot be retried:
rolling back changes made to the at least one data storage location with information related to the transaction; and
undoing additional actions taken by a user after the updating of the at least one data storage location with information related to the transaction.

13. The at least one non-transitory, computer-readable medium of claim 12, wherein the information related to the transaction comprises:
identity of the blockchain-based asset,
identity of a user associated with the transaction,
type of the transaction,
currency associated with the transaction,
or any combination thereof.

14. The at least one non-transitory, computer-readable medium of claim 12, wherein the at least one transaction is transmitted to the blockchain based on a prediction score or a trigger event,
wherein the trigger event is based on:
a configurable frequency,
a time period,
number of transactions,
type of the transaction,
priority of the transaction,
identity of a buyer associated with the transaction,
identity of a seller associated with the transaction,
currency associated with the transaction,
or any combination thereof; and
wherein the prediction score is based on:
type of the application,
transaction history of a user associated with the transaction,
type of the transaction,
amount associated with the transaction,
gas price of the transaction,
number of previously submitted confirmations for the transaction,
or any combination thereof.

15. The at least one non-transitory, computer-readable medium of claim 12, wherein the operations further comprise:
executing the at least one transaction to change the state of the blockchain to reflect the at least one transaction.

16. The at least one non-transitory, computer-readable medium of claim 12, wherein the updating of the at least one data storage location is based on a prediction score or a trigger event,
wherein the trigger event is based on:
a configurable frequency,
a time period,
number of transactions,
type of the at least one transaction,
priority of the at least one transaction,
identity of a buyer associated with the at least one transaction,
identity of a seller associated with the at least one transaction,
currency associated with the at least one transaction,
or any combination thereof.

17. The at least one non-transitory, computer-readable medium of claim 12, wherein the operations further comprise:
receiving confirmation or a set of events confirming that the transaction will not be rejected by the blockchain,
wherein the updating of the at least one data storage location occurs after the confirmation or the set of events is received.

18. The at least one non-transitory, computer-readable medium of claim 12, wherein when the confirmation of the execution of the transaction on the blockchain indicates that the transaction executed successfully, the operations further comprise:
updating a state change indicator to closed at the at least one data storage location; and
reading a current state of the blockchain to resolve discrepancies at the at least one data storage location.

19. The at least one non-transitory, computer-readable medium of claim 12, wherein determining whether the transaction can be retried comprises:
determining a number of times the transaction has previously been tried; and
when the number of times the transaction has previously been tried exceeds a predetermined threshold, determining that the transaction cannot be retried.

20. A system for performing lazy updates of transactions to a blockchain, the system comprising:
at least one hardware processor;
at least one non-transitory memory, coupled to the at least one hardware processor and storing instructions, which when executed by the at least one hardware processor, perform a process, the process comprising:
receiving at least one action to initiate a transaction related to a blockchain-based asset,
wherein executing of the transaction changes a state of the blockchain to reflect the transaction;
updating at least one data storage location with information related to the transaction,
wherein the updating of the at least one data storage location comprises modifying a token item associated with the blockchain-based asset;
transmitting the transaction to the blockchain for execution;
receiving a confirmation of the execution of the transaction on the blockchain;
when the confirmation of the execution of the transaction on the blockchain indicates that the transaction executed successfully:
marking the transaction as complete to prevent retries; and
changing a transaction state to a closed state.
